(19) United States
(12) Patent Application Publication
(10) Pub. No.: US 2018/0171661 A1
(43) Pub. Date: Jun. 21, 2018

(54) ACCESS PREVENTION SYSTEMS FOR LOCKS OF ELEVATOR SYSTEMS

(71) Applicant: Otis Elevator Company, Farmington, CT (US)

(72) Inventors: Aurelien Fauconnet, Isdes (FR); Frederic Beauchaud, Coullons (FR)

(21) Appl. No.: 15/828,561

(22) Filed: Dec. 1, 2017

(30) Foreign Application Priority Data
Dec. 15, 2016 (EP) 16290234.0

(51) Int. Cl. E05B 17/14; B66B 5/00

(52) U.S. Cl. CPC E05B 17/14; B66B 5/005

(57) ABSTRACT

Access prevention systems for locks of elevator systems, the access prevention systems including a lock housing defining a cavity and having a lock aperture enabling access into the cavity, a locking element attached to the lock housing and accessible through the lock aperture and the cavity, and an access prevention device operable between (i) a first state wherein a portion of the access prevention device obstructs access to the locking element through at least one of the cavity and the lock aperture and (ii) a second state wherein the access prevention device does not obstruct access to the locking element.

### CROSS-REFERENCE TO RELATED APPLICATIONS

This application claims the benefit of European Application No. 16290234.0 filed on Dec. 15, 2016, which is incorporated herein by reference in its entirety.

### BACKGROUND

The subject matter disclosed herein generally relates to elevator systems and, more particularly, to access prevention systems and devices for locks of elevator systems.

Elevator systems include locking mechanisms that are useable by mechanics, technicians, and other authorized persons. The locking mechanisms can be part of lintels or door column or trap inside the car of the elevator systems and thus may be easily accessible by anyone. However, it may be required by safety regulations and/or advantageous to prevent access to and/or operation of the elevator locking mechanisms at certain times (e.g., when a technician or mechanic is performing a maintenance operation) or when authorized access is not proper. Accordingly, devices that prevent access to the elevator system locking mechanisms may be desirable.

### SUMMARY

According to some embodiments, access prevention systems for locks of elevator systems are provided. The access prevention systems include a lock housing defining a cavity and having a lock aperture enabling access into the cavity, a locking element attached to the lock housing and accessible through the lock aperture and the cavity, and an access prevention device operable between (i) a first state wherein a portion of the access prevention device obstructs access to the locking element through at least one of the cavity and the lock aperture and (ii) a second state wherein the access prevention device does not obstruct access to the locking element.

In addition to one or more of the features described above, or as an alternative, further embodiments of the access prevention systems may include that the access prevention device includes an access prevention device housing coupled to the lock housing and a securing element operable between an extended position and a retracted position, wherein in the extended position the securing element obstructs access to the locking element.

In addition to one or more of the features described above, or as an alternative, further embodiments of the access prevention systems may include a driving element operable to drive the securing element from the extended position to the retracted position.

In addition to one or more of the features described above, or as an alternative, further embodiments of the access prevention systems may include that the driving element is a solenoid.

In addition to one or more of the features described above, or as an alternative, further embodiments of the access prevention systems may include a track within the access prevention device housing, wherein the securing element is movable along the track.

In addition to one or more of the features described above, or as an alternative, further embodiments of the access prevention systems may include a cover disposed within the cavity that covers the lock aperture when the access prevention device is in the first state.

In addition to one or more of the features described above, or as an alternative, further embodiments of the access prevention systems may include a pivot that movably attaches the cover to the lock housing.

In addition to one or more of the features described above, or as an alternative, further embodiments of the access prevention systems may include a controller operable to control the access prevention device to operate between the first and second states.

In addition to one or more of the features described above, or as an alternative, further embodiments of the access prevention systems may include that the controller is housed within the access prevention device.

In addition to one or more of the features described above, or as an alternative, further embodiments of the access prevention systems may include that the controller is an elevator system controller.

In addition to one or more of the features described above, or as an alternative, further embodiments of the access prevention systems may include a power source operably connected to the access prevention device.

In addition to one or more of the features described above, or as an alternative, further embodiments of the access prevention systems may include a recess formed in a portion of the lock housing, wherein a portion of the access prevention device is receivable within the recess when in the first state.

In addition to one or more of the features described above, or as an alternative, further embodiments of the access prevention systems may include a lintel of an elevator landing door wherein the lock housing, the locking element, and the access prevention device are installed within the lintel to lock the elevator landing door.

Technical effects of embodiments of the present disclosure include access prevention systems and devices for locks of elevator systems that prevent unauthorized access to the locks. Further technical effects include a default position that prevents access to the lock of an elevator system and requires action or energization to enable access to be permitted.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a schematic illustration of a landing floor of an elevator system with a hall call panel that may employ various embodiments of the present disclosure;

FIG. 3 is a schematic illustration of a lock of an elevator system that can incorporate embodiments of the present disclosure;

FIG. 4A is a schematic illustration of a lock of an elevator system and access prevention device in accordance with an embodiment of the present disclosure;

FIG. 4B is a cross-sectional illustration of the lock of the elevator system and access prevention device of FIG. 4A in a first state;

FIG. 4C is a cross-sectional illustration of the lock of the elevator system and access prevention device of FIG. 4A in a second state;

FIG. 4D is a cross-sectional illustration of the lock of the elevator system and access prevention device of FIG. 4A in a third state;

FIG. 5A is a schematic illustration of a lock of an elevator system and access prevention device in accordance with another embodiment of the present disclosure shown in a first state; and

FIG. 5B is a schematic illustration of the lock of the elevator system and access prevention device of FIG. 5A shown in a second state.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

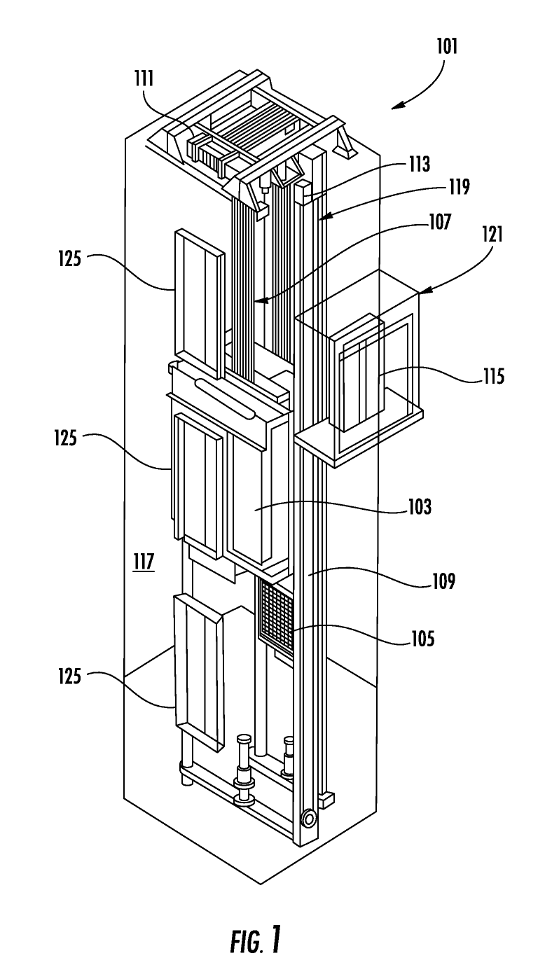

FIG. 1 is a perspective view of an elevator system 101 including an elevator car 103, a counterweight 105, a roping 107, a guide rail 109, a machine 111, a position encoder 113, and an elevator controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

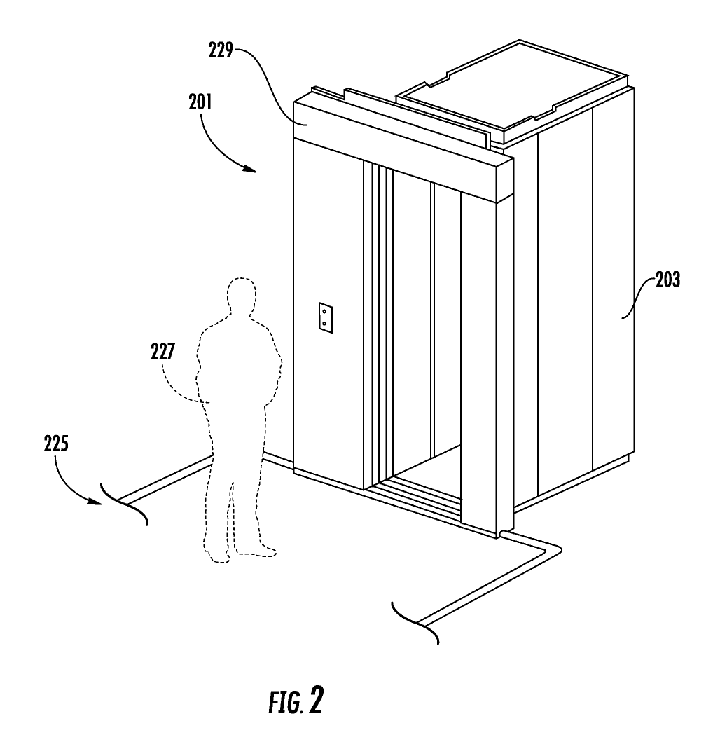

FIG. 2 is a schematic illustration of an elevator system 201 that may incorporate embodiments disclosed herein. As shown in FIG. 2, an elevator car 203 is located at a landing 225. The elevator car 203 may be called to the landing 225 by a passenger or mechanic 227 that desires to travel to another floor within a building or perform maintenance on the elevator system 201. In some situations, the mechanic 227 may wish to lock a feature of the elevator system, e.g., the elevator doors, an elevator trap, etc., such that they cannot be opened or closed (e.g., to prevent unauthorized persons from accessing the elevator system 201 or portions thereof). For example, such situation may arise when the mechanic 227 wishes to enter the elevator pit to perform maintenance therein. As shown, such control or locking can be achieved by a lock hole in a lintel 229 of the elevator system 201 (which may be located at each landing 225). It may be advantageous to prevent unauthorized persons from accessing the lock. Accordingly, embodiments provided herein are directed to access prevention systems and devices to prevent access to the locks of elevator systems, the systems securely preventing unauthorized access to the locks of the elevator system.

Turning to FIG. 3, a key 300 for use with a lock 302 of an elevator in accordance with an embodiment of the present disclosure is shown. As shown, the lock 302 is an elevator door lock located within a lintel 329 of an elevator doorway. The key 300 is configured to fit within an aperture of the lock 302. Those of skill in the art will appreciate that the locks and keys described herein are not limited to door locks, but rather may be employed in any locks of elevator systems. For example, in other configurations, the lock may be part of a door column or trap inside an elevator car or may be a lock of other parts of elevator systems. Thus, FIG. 3 is merely illustrative and not intended to be limiting. The lock 302 can include an access prevention device as described herein that is configured within the lock 302 to prevent the key 300 from entering the aperture of the lock 302. To enable engagement between the key 300 and the lock 302, a mechanic must take affirmative action (e.g., operating a controller) to disengage or deactivate the access prevention device.

As provided herein, embodiments of the present disclosure are configured to control access to a lock of an elevator system by putting in place an obstacle between the lock aperture and a locking device or element that is interacted with a key. For example, an obstacle can be placed to prevent a key from being inserted into and through a lock aperture and thus the key cannot interact with various locking/unlocking elements to operate the lock. In some embodiments, a controller (e.g., computer, processor, etc.) and related software can be configured to pilot and provide authorization to rend locks accessible for mechanics once a specific mode is activated in a control cabinet (e.g., specific elevator control or operation mode).

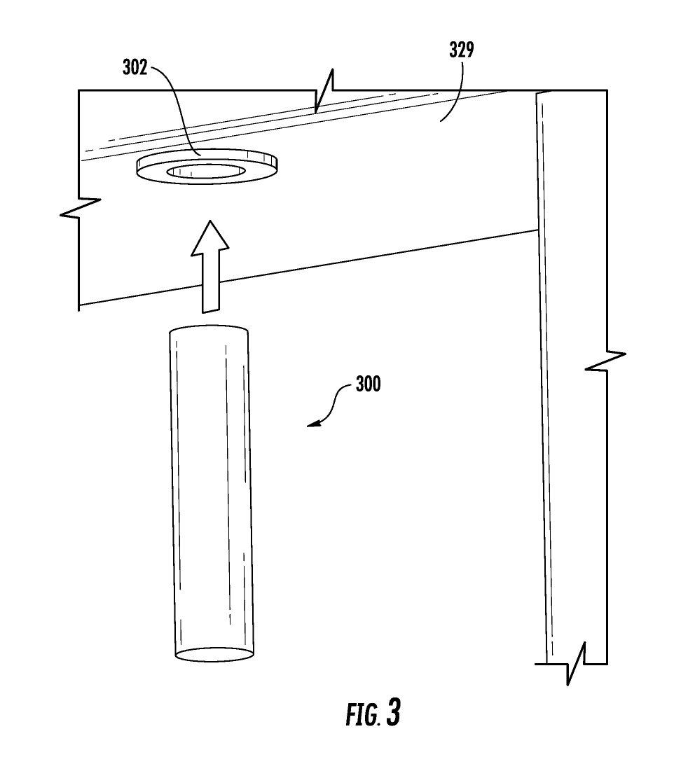

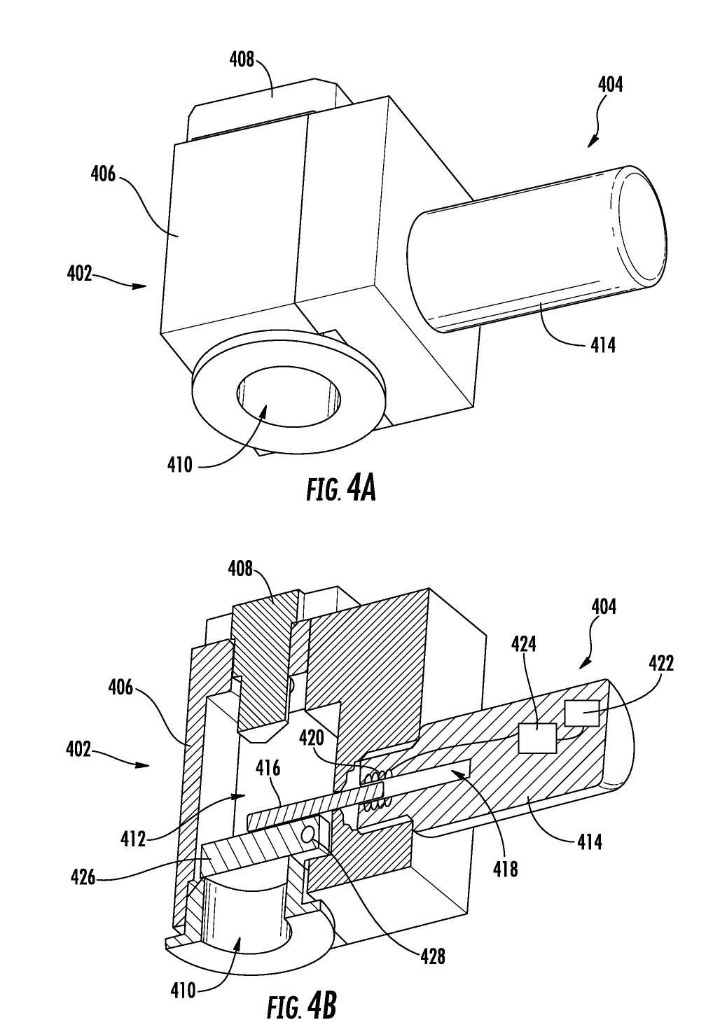

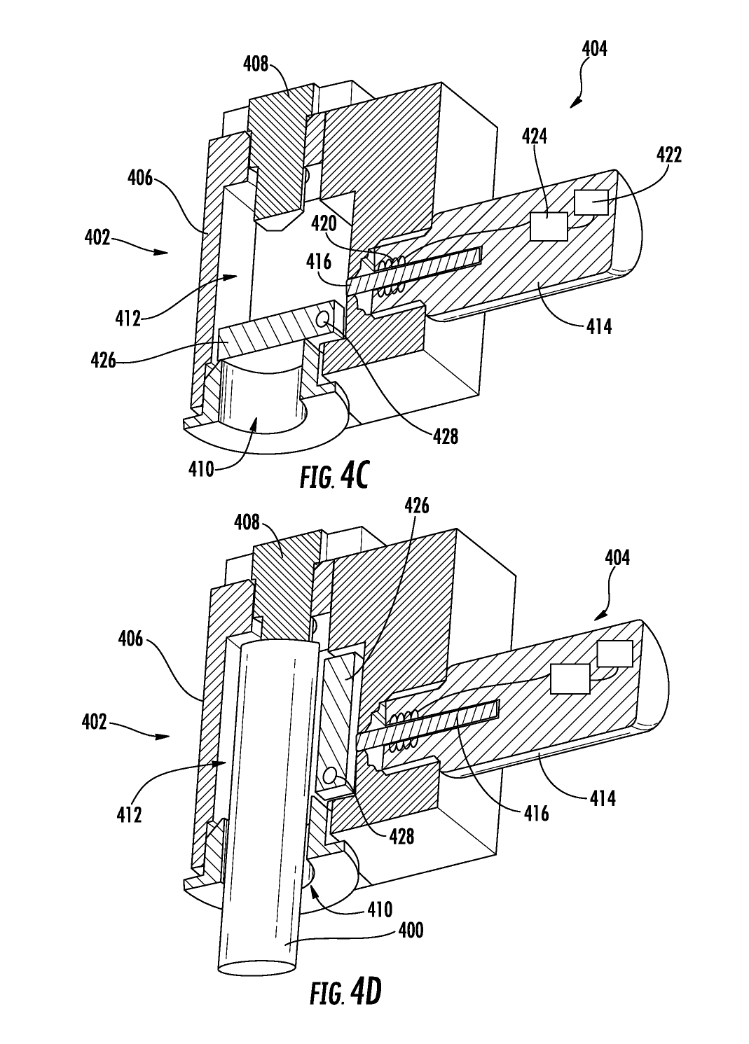

Turning now to FIGS. 4A-4D, schematic illustrations of a lock 402 of an elevator system having an access prevention device 404 in accordance with a non-limiting embodiment of the present disclosure are shown. Those of skill in the art will appreciate that the lock as described herein is representative and illustrative, and other types of elevator system locks can employ embodiments described herein. FIG. 4A is an isometric illustration of the lock 402 and access prevention device 404 as assembled and installable into a lintel or frame of an elevator system. FIG. 4B is a cross-sectional illustration of the lock 402 and access prevention device 404 in a first state. FIG. 4C is a cross-sectional illustration of the lock 402 and access prevention device 404 in a second state. FIG. 4D is a cross-sectional illustration of the lock 402 and access prevention device 404 in a third state.

As shown, the lock 402 includes a lock housing 406, a locking element 408 coupled to the lock housing 406, and a lock aperture 410 enabling access to the locking element 408. The lock housing 406 defines a cavity 412 therein that is configured to enable operation of the access prevention device 404 as described herein. The locking element 408 is a component that is designed, shaped, and configured to enable interaction with a key to enable unlocking of the lock 402 (e.g., an elevator door, trap, etc.). As illustrated, the lock housing 406 and a component defining the lock aperture 410 are separate components. However, those of skill in the art will appreciate that the lock housing 406 can have the lock aperture 410 formed therein, thus eliminating the separate component.

As shown, the cavity 412 within the lock housing 406 separates the lock aperture 410 from the locking element 408. The distance between the lock aperture 410 and the locking element 408 may discourage or prevent a casual user from accessing and operating the lock 402. However, further access prevention may be desirable. Accordingly, as shown, the lock 402 is configured with an access prevention device 404.

The access prevention device 404 is arranged with respect to the lock housing 406 such that in a first state (FIG. 4B) a portion of the access prevention device 404 will prevent access to the locking element 408. The access prevention device 404 includes an access prevention device housing 414 and a securing element 416 that is movable within the access prevention device housing 414. The securing element 416 is configured to be moveable along a track 418 within the access prevention device housing 414. In some non-limiting embodiments, the securing element 416 is a movable rod, pin, or other similar structure.

The securing element 416 is a driven device that moves from an extended position (FIG. 4B) to a retracted position (FIG. 4C). The securing element 416 in the embodiment of FIGS. 4A-4D is driven by a driving element 420. When the driving element 420 is unpowered, the securing element 416 is in the extended position. However, when power is supplied to the driving element 420, the securing element 416 is driven or urged from the extended position into the retracted position. As shown, when in the retracted position, the securing element 416 is housed within the access prevention device housing 414.

The driving element 420 can be controlled by a controller 422, which, as shown, is contained within the access prevention device housing 414. The controller 422 can be a microprocessor, electronic device, electromechanical device, or other type of controller. In some configurations, the controller 422 includes a processor, memory, and communications component that is configured to communicate (wired and/or wirelessly) with a remote control device. The controller 422, as shown, is operably connected to a power source 424, such as a battery, that is further connected to the driving element 420 to enable energization of the driving element 420 when a command is provided from the controller 422. In other embodiments, the power source 424 can be an electrical power source that is supplied from a location external from the access prevention device 404, such as grid power, generator power, back-up battery power configured with an elevator system, etc.

Further, in some embodiments, the controller 422 may be remote from the access prevention device 404. That is, a computer, elevator controller (e.g., elevator controller 115 shown in FIG. 1), or other control system can be used instead of or in combination with an onboard controller, without departing from the scope of the present disclosure. In some such embodiments, the access prevention device 404 may be wired such that an electrical signal can be provided to the access prevention device 404 and the electrical signal energizes the driving element 420 to operate the securing element 416 from the extended position to the retracted position.

In the embodiment of FIGS. 4A-4D, the securing element 416 interacts with a cover 426 to prevent access to the locking element 408 through the lock aperture 410. That is, the cover 426 is configured to securely cover the lock aperture 410 when the securing element 416 is in the extended position. The securing element 416 is rigidly retained and held in the extended position such that application of force applied to the cover 426 through the lock aperture 410 cannot move the cover 426 and thus enable access to the locking element 408.

The cover 426 is hinged about a pivot 428. In some embodiments, the pivot 428 can be optionally biased to retain the cover 426 in the closed position (e.g., FIG. 4C) such that even when the driving element 420 is energized and the securing element 416 is retracted, the lock aperture 410 remains closed or covered. Other mechanisms for retaining the cover 426 in the closed position can be employed without departing from the scope of the present disclosure, including, but not limited to, a magnetic engagement between the cover 426 and the opening around the lock aperture 410 that is within the cavity 412 of the lock housing 406. In other embodiments, the securing element 416 can be operably connected to the cover 426 such that when the securing element 416 is pulled or urged into the retracted position a portion of the securing element 416 pulls on or otherwise interacts with the cover 426 to pull the cover into an open position (FIG. 4D).

As shown in FIG. 4D, with the securing element 416 in the retracted position, the cover 426 can be opened to expose the lock aperture 410. Thus, a key 400 can be inserted into and through the lock aperture 410 and interact with the locking element 408. After a mechanic accesses the locking element 408 and a key is removed, power can be turned off from the driving element 420 and the securing element 416 will move back to the extended position and secure the cover 426 over the lock aperture 410.

Thus, in operation, the lock 402 and access prevention device 404 are in a first state when no power is provided to the access prevention device 404, as shown in FIG. 4B. In the first state, the securing element 416 is extended and the cover 426 is closed. Thus, in the first state, a key cannot be inserted into and through the lock aperture 410 to interact with the locking element 408. When desired to be operated, power is supplied to the access prevention device 404 and the access prevention device 404 is moved into a second state, as shown in FIG. 4C. In the second state, the securing element 416 is retracted into the access prevention device housing 414 and the securing element 416 no long contacts or retains the cover 426 in the closed position. Then, in the third state, the cover 426 is opened, as shown in FIG. 4D. The change from the second state to the third state can be achieved by a mechanic inserting the key 400 into the lock aperture 410 and pushing the cover 426 into the open position. The inserted key 400 can then be used to actuate the locking device 408 to unlock the lock 402, such as a landing door of an elevator system, a trap, etc.

The driving element 420 may be configured as a solenoid operable on a pin or rod, although other configurations of the securing element are possible without departing from the scope of the present disclosure. For example, in some embodiments, the securing element can be part of an electrical cylinder, a piston configuration, a plunger configuration, or other mechanical extension that can extend and be retracted to prevent access through the lock aperture. Further, in some embodiments, the lock housing and the access prevention device housing can be integrally formed, with the various components installed therein.

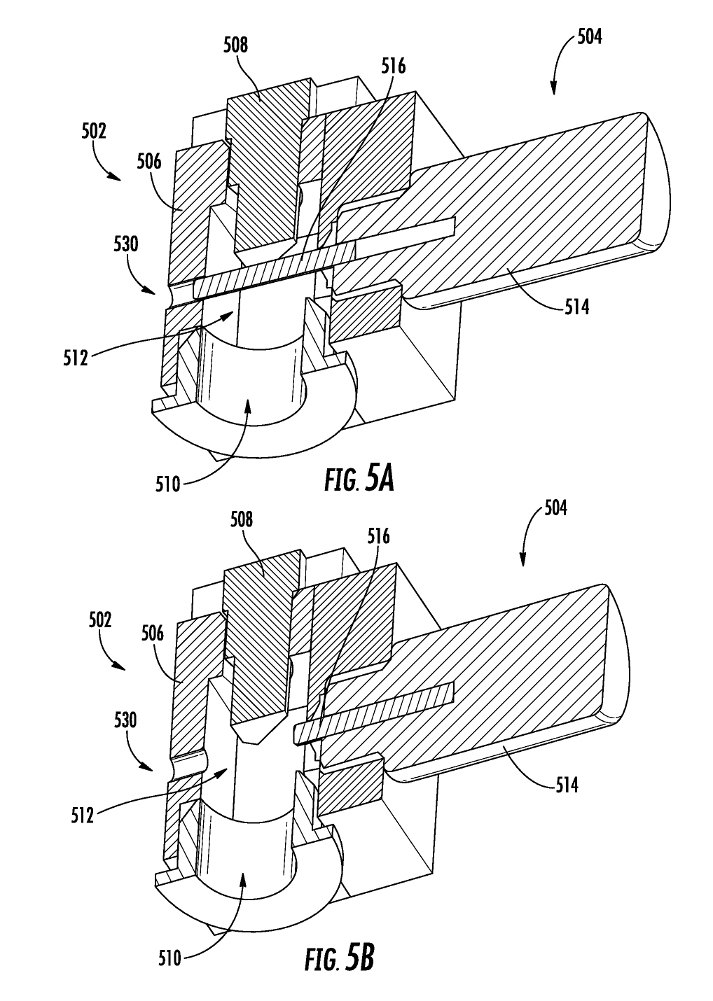

Turning now to FIGS. 5A-5B, an alternative non-limiting embodiment of the present disclosure is shown. FIG. 5A is a schematic illustration of a lock 502 of an elevator system having an access prevention device 504 in a first state. FIG. 5B is a schematic illustration of the lock 502 and access prevention device 504 in a second state. The lock 502 and access prevention device 504 of the embodiment shown in FIGS. 5A-5B is similar to that shown and described above and thus similar features may be omitted for simplicity and clarity.

For example, the lock 502 includes a lock housing 506, a locking element 508, a lock aperture 510, and a cavity 512, similar to that described above. Similarly, the access prevention device 504 includes a securing element 516 that is operable similar to that described above (e.g., driving element, controller, etc.) within an access prevention device housing 514.

In the embodiment of FIGS. 5A-5B, a cover as described above is not present. That is, the securing element 516 provides the prevention of key access without any other elements. As shown in FIG. 5A, in a first, non-energized state, the securing element 516 is extended such that it spans the cavity 512 such that a key cannot be inserted into and through the lock aperture 510 and access the locking element 508. In the second state, shown in FIG. 5B, the securing element 516 is retracted into the access prevention device housing 514 and does not block access through the cavity 512. As shown in the embodiment of FIGS. 5A-5B, the securing element 516 can engage with a recess 530 that is formed within, through, or as part of the lock housing 506.

Advantageously, embodiments provided herein enable a secure and safe mechanism for preventing access to a lock of an elevator system. Accordingly, unauthorized access to the door lock and thus to opening the elevator doors can be prevented. Further, advantageously, because retraction requires the application of energy, the default position of the access prevention device is such that access cannot be achieved without permission. Further, advantageously, the access prevention devices of the present disclosure are universal and not specific to any particular lock size and/or lock configuration (e.g., elevator doors, traps, columns, etc.).

As used herein, the use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity).

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the spirit and scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. An access prevention system for a lock of an elevator system, the access prevention system comprising:
a lock housing defining a cavity and having a lock aperture enabling access into the cavity;
a locking element attached to the lock housing and accessible through the lock aperture and the cavity; and
an access prevention device operable between (i) a first state wherein a portion of the access prevention device obstructs access to the locking element through at least one of the cavity and the lock aperture and (ii) a second state wherein the access prevention device does not obstruct access to the locking element.

2. The access prevention system of claim 1, wherein the access prevention device comprises:
an access prevention device housing coupled to the lock housing;
a securing element operable between an extended position and a retracted position, wherein in the extended position the securing element obstructs access to the locking element.

3. The access prevention system of claim 2, further comprising a driving element operable to drive the securing element from the extended position to the retracted position.

4. The access prevention system of claim 3, wherein the driving element is a solenoid.

5. The access prevention system of claim 2, further comprising a track within the access prevention device housing, wherein the securing element is movable along the track.

6. The access prevention system of claim 1, further comprising a cover disposed within the cavity that covers the lock aperture when the access prevention device is in the first state.

7. The access prevention system of claim 6, further comprising a pivot that movably attaches the cover to the lock housing.

8. The access prevention system of claim 1, further comprising a controller operable to control the access prevention device to operate between the first and second states.

9. The access prevention system of claim 8, wherein the controller is housed within the access prevention device.

10. The access prevention system of claim 8, wherein the controller is an elevator system controller.

11. The access prevention system of claim 1, further comprising a power source operably connected to the access prevention device.

12. The access prevention system of claim 1, further comprising a recess formed in a portion of the lock housing, wherein a portion of the access prevention device is receivable within the recess when in the first state.

13. The access prevention system of claim 1, further comprising:
a lintel of an elevator landing door;
wherein the lock housing, the locking element, and the access prevention device are installed within the lintel to lock the elevator landing door.
